(19) United States
(12) Patent Application Publication
(10) Pub. No.: US 2003/0091310 A1
(43) Pub. Date: May 15, 2003

(54) Optical fiber assembly using reactive moiety di-terminated diphenylmethane polyol oligomer, and methods for making and using same

(76) Inventor: Timothy E. Myers, Mason, OH (US)

Correspondence Address: STEVENS DAVIS MILLER & MOSHER, LLP, 1615 L STREET, NW, SUITE 850, WASHINGTON, DC, 20036, US

(21) Appl. No.: 10/115,951

(22) Filed: Apr. 5, 2002

Related U.S. Application Data
(60) Provisional application No. 60/281,821, filed on Apr. 6, 2001.

(51) Int. Cl. G02B 6/22; C08F 2/46

(52) U.S. Cl. 385/128; 385/141; 522/6

(57) ABSTRACT

Coated optical fibers with radiation-curable coatings and oligomers comprised of diphenylmethane polyols having a reactive group, typically a reactive moiety independently selected from the group consisting of acrylic, methacrylic, vinylic, allylic, styrenic, acrylamide, norbornenyl, acetylenic, epoxy, mercapto, amino, itanoic and crotonic at each terminus, and processes for preparing such coated optical fibers and coatings.

This claims priority from U.S. Provisional Patent Application No. 60/281,821 filed Apr. 6, 2001, incorporated herein by reference in its entirety.

### BACKGROUND OF THE INVENTION

1. Field of the Invention

The present invention relates to optical fiber assemblies having one or more layers, comprising reactive moiety di-terminated diphenylmethane polyol oligomers, for example, polyfunctional epoxy-based polyacrylates.

2. Background Discussion

Strong optical fibers that have very few intrinsic defects are suitable for light transmission. However, optical fibers are easily damaged by exposure to the environment, including dust and moisture, and even small flaws can render the fiber brittle and easily broken by a weak external force.

Accordingly, optical fibers have conventionally been provided with at least one resin coating, preferably immediately after preparation of the optical fibers. More commonly, two resin coatings are provided, namely a primary or buffer inner coating and a secondary outer coating. U.S. Pat. Nos. 6,048,911 and 6,014,488 to Shustack disclose optical fibers containing either or both primary and secondary coatings. These patents are incorporated herein by reference in their entirety.

The primary coating is applied directly to the glass fiber and, when cured, forms a soft, rubbery, compliant material which serves as a buffer to cushion and protect the fiber by relieving the stresses created when the fiber is bent, cabled or spooled. Such stress might otherwise induce microbending of the fibers and cause attenuation of the light traveling through them, resulting in inefficient signal transmission. The secondary coating is applied over the primary coating and, when cured, functions as a hard protective outer layer, preventing damage to the glass fiber during processing and use.

Certain characteristics are desirable for the primary coating layer. For example, it must maintain adequate adhesion to the glass fiber during thermal and hydrolytic aging, yet be strippable therefrom for splicing purposes. The tensile modulus of the primary coating must be low to cushion and protect the fiber by readily relieving the stresses on the fiber which can induce microbending and consequent inefficient signal transmission. This cushioning effect must be maintained through the temperature range to which the fiber may be exposed throughout its lifetime. Thus, it is necessary for the primary coating to have a low glass transition temperature (Tg). This low glass transition temperature will ensure that the coating remains in its rubbery state throughout the possible use temperature range.

The secondary coating also must have a number of qualities, including a relatively high glass transition temperature (Tg),about 50° C. or higher, and a high tensile modulus, i.e., between about 40,000 and 350,000 psi, e.g., about 100,000 at 25° C. It is desirable for the secondary coating to have a Tg higher than its highest use temperature, because at or near the Tg of a polymer, many physical properties such as modulus, tensile strength, thermal expansion coefficient, moisture absorptivity and so forth, change dramatically with small changes in temperature. This results in large changes in the fiber characteristics.

Both the primary and secondary coating should undergo minimal changes in physical properties on exposure to moisture. Many polymeric coating materials experience significant hydrolysis, plasticization, softening and loss of protective function in the presence of water. Moisture will rapidly degrade the strength of the coating itself as well as the underlying glass fibers under stress. The reaction is one of hydrolysis and stress corrosion. Moisture will also adversely affect the adhesion of the primary coating to the glass, resulting in possible delamination. It is therefore desirable for the coating to be as water resistant as possible.

Yet another desirable property for the primary and secondary coatings is organic solvent resistance. Such solvents can cause the primary coating to swell so severely as to result in delamination of the coatings from the fiber, or to cause the more rigid secondary coating to crack and fall apart. Solvent exposure can be, in the case of “long haul” optical fiber cables, in the form of filling compounds (e.g., mineral oil-based or silicone-based materials), or, in the case of less protected fiber-to-the-home applications, various household solvents such as are present in cleaners, paints, insect repellents and so forth. Therefore, it is desirable that the coatings have a suitable balance between hydrophobicity and hydrophilicity as to achieve optimal performance under all environmental conditions.

Another important property of coatings is that, when cured, they must contain little unbound material. While ultraviolet curable materials are often referred to as 100 percent solids, they may still contain a significant amount of chemically unbound material after the ultraviolet cure. This unbound material can be extractable with solvent or water, or it can be volatile under certain conditions. The presence of an extractable or volatile component in optical fiber products can cause problems detrimental to the fibers. Such problems may manifest themselves throughout the lifetime of the optical fiber.

Both the primary and secondary coatings should also have a relatively high refractive index, i.e., greater than that of the cladding material of the fiber to be coated. This high refractive index allows for a refractive index differential between the glass cladding and the coatings. This differential enables the coatings to strip out errant light, that is, refract errant light signals away from the glass core.

Coatings that have these properties are available, but the components from which they are made are typically expensive. Accordingly, there is a continuing need in the art for less expensive components that meet or exceed the requirements above.

### OBJECTS OF THE INVENTION

It is an object of the present invention to provide a coated optical fiber.

It is another object of the present invention to provide a process for preparing a coated optical fiber.

It is another object of the present invention to provide a composition for coating an optical fiber.

It is another object of the invention to provide an optical fiber ribbon.

These and other objects of the invention will become apparent from the following descriptions.

### SUMMARY OF THE INVENTION

The invention includes: (1) an optical fiber assembly comprising an optical fiber having one or more layers, for example, a primary or secondary coating, formed from a reaction mixture that contains, inter alia, reactive moiety di-terminated diphenylmethane polyol oligomers, e.g., acrylate di-terminated diphenylmethane polyol oligomers; (2) a process for preparing an optical fiber by applying to an optical fiber a coating formed from a reaction mixture that contains the epoxy oligomers, and radiation-curing the coating on the optical fiber, i.e., in situ; (3) a composition for coating an optical fiber formed from a reaction mixture that contains the epoxy oligomers; and (4) an optical fiber ribbon including the above-described optical fibers and coating, and a matrix material, the fibers held together in a parallel arrangement by the matrix material. The layer may typically be in the form of primary coating, a secondary coating, a matrix material, a buffering material or an upjacket.

The inventive layer reduces the cost of optical fibers by enabling replacement of a larger portion of the relatively expensive base component of the coating, (which are reactive oligomers selected from the group consisting of urethane oligomer, polyester acrylate oligomer, and/or acrylic acrylate oligomer, wherein urethane oligomer is preferred), with less expensive additive oligomers.

These additive oligomers according to the present invention include radiation-curable, polyfunctional, diphenylmethane polyol oligomers with a reactive moiety, preferably an acrylate or methacrylate group at each terminus or, in particular at least one radiation-curable diphenylmethane polyol oligomer, wherein each terminus of the polyol oligomer is capped by an acrylate moiety (to form a reactive epoxy acrylate oligomer).

The reactive moiety may be, for example, selected from the group consisting of acrylic, methacrylic, vinylic, allylic, styrenic, acrylamide, norbomenyl, acetylenic, epoxy, mercapto, amino, itanoic and crotonic moieties.

Hereinafter, these additive oligomers shall generally be referred to as the “epoxy oligomers” or the “polyol oligomers”. Also, “acrylated” shall generally imply “methacrylated” and “polyacrylated” shall generally imply “polymethacrylated,” unless the context clearly indicates otherwise, e.g., in lists of formally named compounds.

The polyol oligomer comprises from about 1 to about 5 diphenylmethane groups. Preferably, the diphenylmethane groups help form the main backbone of the molecule, as opposed to being substituents thereon. It is also preferred that the diphenylmethane groups be substituted, more preferably the root methane of the diphenylmethane is substituted by lower alkyl, still more preferably the methane is di-substituted with methyl. Most preferably, diphenylmethane groups are immediately proximate to hydroxy, ester or partially saturated ester groups. For example, the diphenylmethane groups may be attached directly to an oxygen bridge that is in turn attached to a carbonyl or hydroxy bearing carbon. More specifically, diphenylmethane groups are preferably only 0 to 4 intermediate atoms away from the hydroxy bearing carbon. Still more preferably, one of the intermediate atoms is an oxygen bridge and the diphenylmethane groups are located 0 to 1 carbons away from the oxygen bridge which in turn is located 0 to 2 intermediate atoms from the hydroxy bearing carbon. Most preferably, the diphenylmethane groups are located 0 or 1 carbons away from the oxygen bridge which is in turn 0 or 1 intermediate atoms away from the hydroxy bearing carbon.

Typically, the polyol oligomer comprises from about 2 to about 6 hydroxy groups. Preferably, one hydroxy group is proximate to each terminus of the oligomer, more preferably a hydroxy bearing carbon is located just to the inside of the acrylate terminus, for example about 0 to about 3 intermediate atoms inside from the acrylate group. Still more preferably, in addition to the hydroxy groups proximate the termini, about 1 to about 4 hydroxy groups are located toward the center of the molecule, for example, at least 6 to 9 intermediate atoms inside of the acrylate groups. Even more preferably, these centrally located hydroxy groups are proximate to the diphenylmethane groups as described in the foregoing paragraph.

Typically, the polyol oligomers are derived from polyfunctional polyacrylated bisphenol diglycidyl ethers. Preferably, the bisphenol diglycidyl ethers are formed from the reaction of a halohydrin and a bisphenol, more preferably bisphenol A. Still more preferably, the epoxy oligomers are only diacrylated, with a single acrylate group on each terminus. In the most preferred embodiments, the polyol oligomer comprises a compound represented by the following Formulas I and, typically, IA:

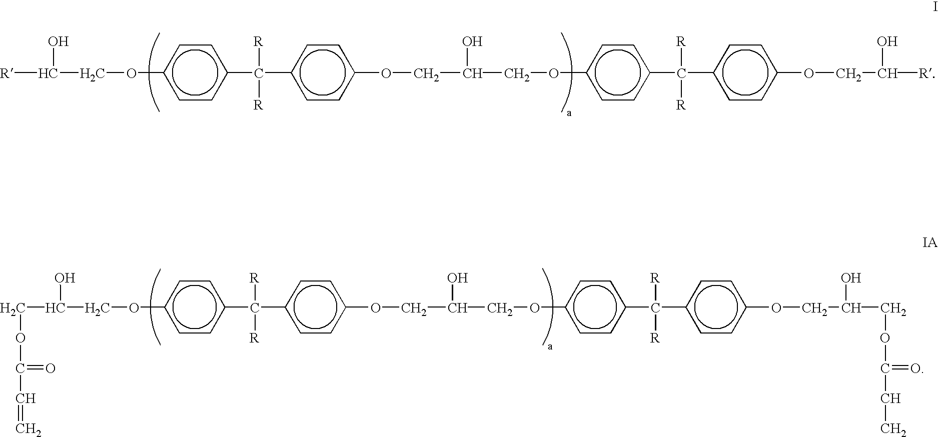

In Formula I, R′ is a reactive moiety selected from the group consisting of acrylic, methacrylic, vinylic, allylic, styrenic, acrylamide, norbornenyl, acetylenic, epoxy, mercapto, amino, itanoic and crotonic moieties. In both Formulas I and IA, a is 0 to 4, typically 0, 1, 2, 3 or 4, for example 0.5 to 3, and R is hydrogen, methyl or linear or branched lower alkyl having 1 to about 6 carbon atoms, typically 1 to about 4 carbon atoms, either a linear or branched chain. Examples of R include methyl, ethyl, propyl, isopropyl, butyl, isobutyl, tert-butyl, pentyl, isopentyl, neopentyl, hexyl and the like. The R on one side may be the same or different from the R opposite it. Preferably one R is methyl; more preferably each R is methyl.

The base oligomer is preferably a urethane acrylate formed from the reaction of (i) at least one polyol selected from the group consisting of polyether polyols, hydrocarbon polyols, polycarbonate polyols and polyisocyanate polyols; (ii) a polyisocyanate; and (iii) an endcapping monomer supplying a reactive terminus. Polyester acrylates and acrylic acrylates will also suffice.

The polyester acrylate oligomer also useful as a base oligomer is preferably made by the condensation of acrylic acid with hydroxyl groups on a polyol or polyester backbone or hydroxy acrylate with residual acid groups on a polyester structure.

The acrylic acrylate oligomer also useful as a base oligomer preferably comprises at least one radiation-curable (meth)acrylate group, and preferably, at least one acrylate group. These are known in the art as acrylated acrylics. The invention is not believed to be limited by how the acrylated acrylic oligomer, or any other oligomer, is prepared. Oligomer synthetic routes for acrylated acrylics can, for example, involve an esterification of a hydroxyl functional acrylic oligomer with (meth)acrylic acid, or the reaction of an epoxy-functional acrylic oligomer with (meth)acrylic acid. These acrylated acrylics can include urethane linkages. Acrylated acrylics can be prepared by known synthetic methods including, for example, (1) partial esterification of acrylic polymers having pendant carboxylic acid group with hydroxyethyl acrylate or glycidyl methacrylate, or in the alternative, acrylation of glycidyl methacrylate terpolymer with acrylic acid, or (2) polymerization of monomers which already have acrylate groups such as, for example, allyl methacrylate or N,N-dimethylaminoethyl methacrylate. The acrylic oligomer typically will have a copolymeric backbone. The glass transition temperature (Tg) of the oligomer can be lowered by decreasing the content of methyl methacrylate.

Further preferred embodiments of the invention include one or more of the following characteristics. The ingredients that form the coating include, based on the weight of all of the ingredients, about 10 weight percent to about 90 weight percent of the base oligomer, for example, urethane oligomer, from about 5 weight percent to about 80 weight percent of the polyol oligomer, from about 10 to about 80 weight percent reactive diluent monomer, and from about 0 weight percent to about 10 weight percent of the photoinitiator. (There may be 0 weight percent photoinitiator when curing through electron beam irradiation.) More preferably, the ingredients include about 40 weight percent to about 80 weight percent of the urethane acrylate base oligomer, from about 20 weight percent to about 50 weight percent of the epoxy oligomer, from about 20 to about 65 weight percent reactive diluent monomer (percentages from provisional), and from about 1 weight percent to about 5 weight percent of the photoinitiator.

Preferably, a mixture of the urethane oligomer and the polyol oligomer (also known as epoxy oligomer) is liquid at 5 to 25° C. This liquid mixture preferably exhibits good optical clarity, i.e., a UV absorbance when measured at 25° C., through a 1 cm pathlength, and at 500 nm relative to distilled water of less than about 0.04, most preferably less than 0.02.

The layers employed in the optical fibers according to the present invention may form, for example, primary coating, secondary coating, matrix, upjacket or buffering materials. They exhibit a combination of good abrasion resistance, moisture resistance, thermal stability and other desired characteristics.

The above described and other objects of the present invention are apparent from the following description.

### BRIEF DESCRIPTION OF THE DRAWINGS

FIG. 1 is a cross-sectional side view of a portion an of optical fiber ribbon.

FIG. 1A is a cross-sectional view of a coated optical fiber of the optical fiber ribbon of FIG. 1 being cut for stripping.

### DESCRIPTION OF THE PREFERRED EMBODIMENTS

Embodiments of the optical fiber assemblies of the present invention include coated optical fibers which comprise a glass coated fiber and a radiation-cured coating on the fiber. The glass optical fiber may be of any design known in the art. For example, the glass fiber may comprise a glass core and a glass cladding layer. The core may comprise silica doped with oxides of germanium or phosphorous or other impurities, and the cladding may comprise a pure or doped silicate, for example a fluorosilicate. In an alternative embodiment, the glass fibers may comprise a polymer-clad silica glass core. Examples of polymer claddings known in the art and suitable for use in this embodiment include organosiloxanes such as polydimethylsiloxane, fluorinated acrylic polymer or the like. Glass optical fibers of these types are well known in the art and are suitable for use in the present invention.

At least one radiation-cured coating according to the present invention is provided on the glass optical fiber. The radiation-cured coating according to the present invention may be applied directly to the glass optical fiber or, alternatively, to the glass optical fiber, in which case it is a secondary coating. Alternatively, the inventive coating may form both the primary and secondary coatings on an optical fiber and/or form a matrix, a buffer layer or an upjacket layer about the optical fiber.

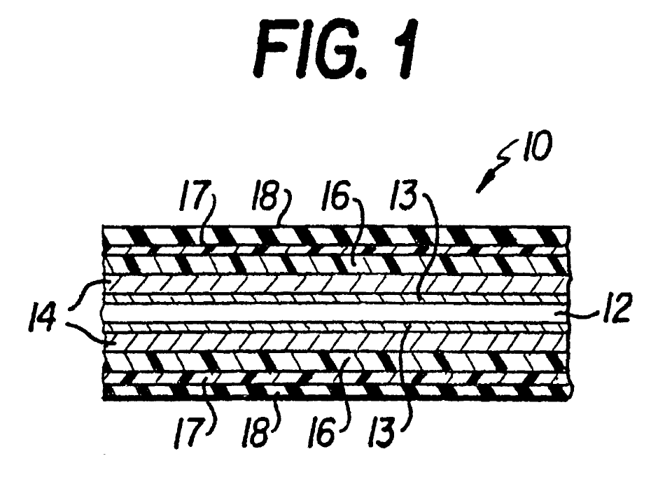

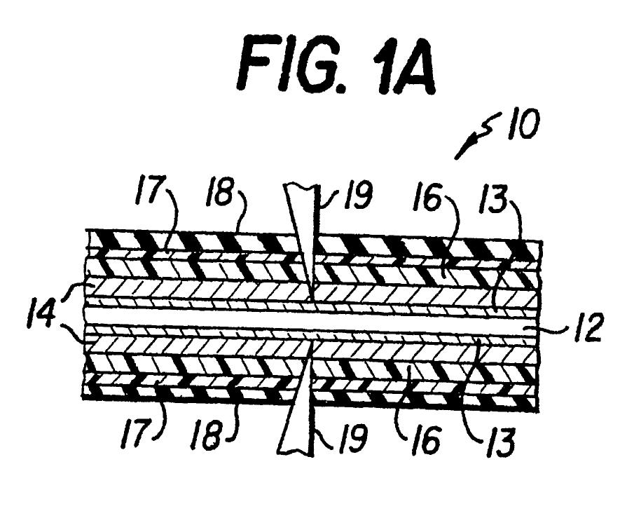

As shown in FIG. 1, a typically coated fiber 10 has a glass core 12, cladding 13, a primary coating 14, a secondary coating 16, ink 17 and a matrix 18 for holding a plurality of coated optical fibers together to form an optical ribbon. FIG. 1A shows the coated optical fiber of FIG. 1 being cut prior to stripping by blades 19.

Generally the primary coating 14 and secondary coating 16 are each approximately 1 mil thick. Ink, if any, may be present as a layer 17 that is 3-5 microns thick and located between the matrix 18 and the outer surface of the secondary coating 16.

Buffer layers (not shown), e.g., buffer tubes, typically surround one or more optical fibers. An upjacket (not shown) is a protective layer about one or more optical fibers. A buffer tube and upjacket are shown in U.S. Pat. No. 6,249,629 to Bringuier incorporated herein by reference.

### Layer Components

An exemplary reaction mixture that forms a layer as either a primary coating, a secondary coating, a matrix, a buffer layer or an upjacket possessing the desired properties comprises the following components:

(1) reactive base oligomer, such as urethane oligomer(s), polyester acrylate oligomer(s), and/or acrylic acrylate oligomer(s);

(2) reactive moiety, e.g. acrylate, di-terminated diphenylmethane polyol oligomer, capable of reacting with a reactive termini of the base oligomer and other polyol oligomers

(3) reactive diluent monomer

(4) optional photoinitiator;

(5) optional adhesion promoter; and

(6) optional stabilizer.

Without intending to be limited in any way to this function, the typical function of the second component (epoxy oligomer) is to lower the cost of the resultant mixture while still providing a composition which meets the needs of the fiber optic industry, such as proper Tg, good elongation and rupture strength, and suitable hydrolytic and thermal resistance.

The following sections describe the above components in greater detail.

I. Reactive Base Oligomer

A. Urethane Oligomer

In one embodiment of the invention, the base oligomers are capable of homopolymerization. Preferably, they are urethane oligomers that are wholly aliphatic and are acrylate-terminated.

The base oligomer constitutes from about 10 percent to about 90 percent by weight of the uncured coating material, based on the total weight of the ingredients. Preferably, it comprises a urethane oligomer that constitutes from about 40 percent to about 80 percent by weight of the ingredients based upon the total weight of all ingredients. If less than about 10 percent by weight is used, flexibility, elongation to break and overall toughness suffer. If too large percent by weight is used, the formulation becomes prohibitively costly in direction proportion to the amount of component A used.

The acrylate-terminated urethane oligomer preferably utilized in the present invention is the reaction product of (i) an aliphatic polyol; (ii) a polyisocyanate, for example an aliphatic polyisocyanate or an aromatic polyisocyanate; and (iii) an endcapping monomer capable of supplying a reactive terminus, either acrylate or methacrylate. The urethane oligomer may contain urethane acrylates based on polyesters and acrylics, but preferably only contains the above kinds of oligomers, for optimal long term stability.

The reagent polyol (i) may be an aliphatic polyol which does not adversely affect the properties of the ingredients when cured. Examples include polyether polyols; hydrocarbon polyols; polycarbonate polyols; polyisocyanate polyols; and mixtures thereof. Polyether polyol backbones are preferred, because, in general, they have good solvent resistance, high elongation and good hydrolytic stability. The polyether polyol is typically based on a straight chain, branched or cyclic alkylene oxide wherein the alkyl group contains about one to about twelve carbon atoms. Typical polyols include polyether diols and triols.

A representative polyether polyol is based on a straight chain, cyclic, or branched alkylene oxide wherein the alkyl group contains from one to about twelve carbon atoms. The polyether polyol may be prepared by any method known in the art. Preferably, it has a number average molecular weight (Mn), as determined in this case by vapor pressure osmometry (VPO), per ASTM D-3592, sufficient to give the entire oligomer based on it a molecular weight of not more than about 6,000 daltons, preferably not more than about 5,000 daltons, and more preferably not more than about 4,000 daltons. Examples of suitable diol compounds having a specific polyoxyalkylene structure used in the above-mentioned processes include polyethylene glycol, polypropylene glycol, polytetramethylene glycol, polyhexamethylene glycol, and polyether diols obtained by the ring-opening copolymerization of one or more ion-polymerizable cyclic compounds. Examples of the ion-polymerizable cyclic compounds include cyclic ethers such as ethylene oxide, propylene oxide, butene-1-oxide, isobutene oxide, tetrahydrofuran, 2-methyl tetrahydrofuran, 3-methyl tetrahydrofuran, dioxane, trioxane, tetraoxane, cyclohexene oxide, styrene oxide, epichlorohydrin, glycidyl methacrylate, allyl glycidyl ether, allyl glycidyl carbonate, butadiene monoxide, isoprene monoxide, vinyl oxetane, vinyl tetrahydrofuran, vinyl cyclohexene oxide, phenyl glycidyl ether, butyl glycidyl ether, and benzoic acid glycidyl ester. Polyether diols obtained by the ring-opening copolymerization of one of the above-mentioned ion-polymerizable cyclic compounds and a cyclic imine such as ethyleneimine, beta-propyolactone, a cyclic lactone acid such as glycolic acid lactide, or a dimethylcyclopolysiloxane, can also be used. Here, specific combinations of two or more ion-polymerizable cyclic compounds include a binary copolymer, such as a copolymer of tetrahydrofuran and propylene oxide, copolymer of tetrahydrofuran and 2-methyl tetrahydrofuran, copolymer of tetrahydrofuran and 3-methyl tetrahydrofuran, copolymer of tetrahydrofuran and ethylene oxide, copolymer of propylene oxide and ethylene oxide, copolymer of butene-1-oxide and ethylene oxide, and copolymer of butene-1-oxide and propylene oxide, and a ternary copolymer such as a copolymer of tetrahydrofuran, butene-1-oxide, and ethylene oxide. These ring-opening copolymers may be either a random copolymer or a block copolymer of these ion-polymerizable cyclic compounds. Typical polyether polyols include but are not limited to polytetramethylene polyol, polymethylene oxide, polyethylene oxide, polypropylene oxide, polybutylene oxide, isomers thereof, and mixtures thereof. A particularly preferred polyether polyol comprises at least some units of polytetramethylene oxide and/or polypropylene oxide.

Representative hydrocarbon polyols which may be used include but are not limited to those based on a linear or branched hydrocarbon polymer of from 600 to 4,000 molecular weight such as hydroxyl-terminated, fully or partially hydrogenated 1,2-polybutadiene; 1,4-1,2-polybutadiene copolymers, 1,2-polybutadiene-ethylene or -propylene copolymers, polyisobutylene polyol; mixtures thereof, and the like. Preferably, the hydrocarbon diol is a substantially, fully hydrogenated 1,2-polybutadiene or 1,2-polybutadiene-ethene copolymer. Typical hydrocarbon polyols include but are not limited to fully or partially hydrogenated 1,2-polybutadiene; 1,2-polybutadiene hydrogenated to an iodine number of from 9 to 21; and fully or partially hydrogenated polyisobutylene. Unsaturated hydrocarbon polyols are not as desirable because the oligomers made from them, when cured, are susceptible to oxidation.

Examples of polycarbonate diols include those conventionally produced by the alcoholysis of diethylene carbonate with a diol. The diol can be, for example, an alkylene diol having about 2 to about 12 carbon atoms, such as, 1,4-butane diol, 1,6-hexane diol, 1,12-dodecane diol, and the like. Mixtures of these diols can also be utilized. The polycarbonate diol can contain ether linkages in the backbone in addition to carbonate groups. Thus, for example, polycarbonate copolymers of alkylene oxide monomers and the previously described alkylene diols can be used. Alkylene oxide monomers include, for example, ethylene oxide, tetrahydrofuran, and the like. These copolymers produce cured coatings that exhibit a lower modulus and also inhibit crystallinity of the liquid coating composition compared to polycarbonate diol homopolymers. Admixtures of the polycarbonate diols and polycarbonate copolymers can also be utilized. Representative polycarbonate polyols include but are not limited to the reaction products of dialkyl carbonate with an alkylene diol, optionally copolymerized with alkylene ether diols.

The polyisocyanate component (ii) is preferably non-aromatic. Oligomers based on aromatic polyisocyanates may cause yellowing in the cured coating. Non-aromatic polyisocyanates of from 4 to 20 carbon atoms may be employed. Suitable saturated aliphatic polyisocyanates include but are not limited to isophorone diisocyanate; dicyclohexylmethane-4, 4′-diisocyanate; 1,4-tetramethylene diisocyanate; 1,5-pentamethylene diisocyanate; 1,6-hexamethylene diisocyanate; 1,7-heptamethylene diisocyanate; 1,8-octamethylene diisocyanate; 1,9-nonamethylene diisocyanate; 1,10-decamethylene diisocyanate; 2,2,4-trimethyl-1,5-pentamethylene diisocyanate; 2,2′-dimethyl-1,5-pentamethylene diisocyanate; 3-methoxy-1,6-hexamethylene diisocyanate; 3-butoxy-1,6-hexamethylene diisocyanate; omega, omega′-dipropylether diisocyanate; 1,4-cyclohexyl diisocyanate; 1,3-cyclohexyl diisocyanate; trimethylhexamethylene diisocyanate; 1,3-bis(isocyanatomethyl) cyclohexane; 1,4-diisocyanato-butane; biuret of hexamethylene diisocyanate; norbomane diisocyanatomethyl 2,5(6)-bis(isocyanatomethyl)bicyclo (2,2,1) heptane; and mixtures thereof.

Isophorone diisocyanate is a preferred aliphatic polyisocyanate. Suitable (though less preferred) aromatic polyisocyanates include toluene diisocyanate; diphenylmethylene diisocyanate; tetramethyl xylylene diisocyanate; 1,3-bis(isocyanatomethyl) benzene; p,m-phenylene diisocyanate; 4,4′-diphenylmethane diisocyanate; dianisidine diisocyanate (i.e., 4,4′-diisocyanato-3,3′-dimethoxy-1,1′-biphenyl diisocyanate); tolidine diisocyanate (i.e., 4,4′-diisocyanato-3,3′-dimethy-1,1′-biphenyl diisocyanate); and mixtures thereof. Of the aromatic polyisocyanates, toluene diisocyanate is preferred.

The catalyst, if present, is present in any of the conventional and known catalytically effective amounts sufficient to carry out the urethane synthesis. Suitable catalysts include but are not limited to copper naphthenate, cobalt naphthenate, zinc naphthenate, 1,4-diazabicyclo[2.2.2]octane, or 2,6,7-trimethyl-1,4-diazabicyclo[2.2.2]octane, dibutyl tin dilaurate, dibutyl tin oxide, dibutyl tin di-2-hexoate, stannous oleate, stannous octoate, lead octoate, ferrous acetoacetate, and amines such as triethylamine, diethylmethylamine, triethylenediamine, dimethylethylamine, morpholine, N-ethyl morpholine, piperazine, N,N-dimethyl benzylamine, N,N-dimethyl laurylamine, and mixtures thereof.

The endcapping monomer (iii) may be one which is capable of providing at least one reactive terminus. Suitable hydroxyl-terminated compounds which may be used as the endcapping monomers include, but are not limited to, hydroxyalkyl acrylates or methacrylates. Systems analogous to the acrylate-based compounds, but bearing any reactive end groups, are equally suitable. Various other exemplary end groups capable of reacting upon irradiation or other means, either by free radical initiation or cationic cure, to provide excellent performance coatings include, but are by no means limited to, free radical systems such as thiolene systems (based on the reaction of multifunctional thiols and unsaturated polyenes, such as vinyl ethers; vinyl sulfides; allylic ethers and bicyclicenes); amine-ene systems (based on the reaction of multifunctional amines and unsaturated polyenes); acetylenic systems; systems wherein the reactive portion of the component is internal rather than terminal; other vinylic (e.g., styrenic) systems; acrylamide systems; allylic systems; itaconate systems and crotonate systems; and cationic cure systems such as onium salt-induced vinyl ether systems and epoxy-terminated systems which react by ring-opening; and any others based on compounds possessing reactive termini. In fact, virtually any end groups which cure by irradiation or other means but do not adversely effect the desirable properties (i.e., the oxidative, thermal and hydrolytic stability and the moisture resistance) of the cured composition are envisioned. The analogous systems are further disclosed by U.S. Pat. No. 5,352,712 to Shustack, incorporated herein by reference in its entirety. Typical acrylates and methacrylates include hydroxyethyl acrylate, hydroxyethyl methacrylate, hydroxypropyl acrylate, hydroxypropyl methacrylate, hydroxybutyl acrylate, hydroxybutyl methacrylate, and so forth. A particularly preferred endcapping monomer is hydroxyethyl acrylate or hydroxyethyl methacrylate. The molar ratio of the polyol, diisocyanate and endcapping monomer is preferably approximately 1:2:2.

Commercially available oligomers are suitable for the urethane oligomer component of this invention so long as the cured coating material made therefrom meets the appropriate standards for Tg, percent elongation to break, and tensile strength, modulus and the like. If the material is employed as a primary coating it would meet the appropriate standards for peel back force. By routine testing based on teachings disclosed in this specification, one skilled in the art would test the cured material for such required criteria. Potential resins include but are not limited to the following.

1. ECHO RESINS ALU-350 series resins, i.e., 350, 351, 352, 353 and 354, from Echo Resins and Laboratory, Versailles, MO, are polytetramethylene polyol-based acrylated aliphatic urethane oligomers of increasing molecular weight and viscosity and decreasing modulus with increasing number in the series. Certain physical properties for this series of resins are summarized in TABLE 1:

TABLE 1

| | ALU-350 | ALU-351 | ALU-352 | ALU-353 | ALU-354 |
|---|---|---|---|---|---|
| Density @ 20 C (g/cm³) | 1.052 | 1.048 | 1.027 | 1.019 | 1.019 |
| (lbs/gal) | 8.76 | 8.73 | 8.55 | 8.49 | 8.49 |
| Refractive Index | 1.496 | 1.492 | 1.478 | 1.468 | 1.460 |
| Viscosity | | | | | |
| @ 78 F (cps) | 320,000 | 120,000 | wax | wax | wax |
| @ 140 F (cps) | 7,300 | 5,400 | 8,900 | 21,750 | 30,000-40,000 |
| Color, Gardner | <1 | <1 | <1 | <1 | <2 |
| Functionality | 2 | 2 | 2 | 2 | 2 |
| Percent Shrinkage, Cured | 3.6 | 2.8 | 1.7 | 1.3 | 1.1 |
| Number Average | 1,390 | 1,410 | 2,300 | 3,550 | 4,880 |
| Molecular Weight (VPO) | | | | | |

For these oligomers, number average molecular weight was determined by vapor pressure osmometry (VPO) using a Knauer VPO, calibrated with benzil, tetracosane and polystyrene standards, using toluene as solvent, for 3 minutes at 40° C., zero balance of 9 and range of 8, using a Universal probe.

In general, the lower molecular weight members of the series are preferred because they are less waxy and easier to work with, and because the compositions including them swell less when contacted with solvents which they may encounter.

The methacrylate equivalents of these oligomers are equally suitable.

2. PURELAST aliphatic urethane acrylate oligomers based on polyether backbones, available from Polymer Systems Corporation, Orlando, Fla. Suitable PURELAST oligomers include 566, 566A, 569, 569A, 569V, 586, 586A, 586V, 590, 590A, 595 and 595A, preferably, 590 and 590A. This series of oligomers increases in modulus with increasing number in the series.

Methacrylate analogs of these oligomers are suitable as well.

3. SARTOMER CN 980 and 981, are both polyether-backbone aliphatic urethane acrylates, also from Sartomer Company, Exton, Pa.

4. BR-372, BR-543, BR-571, BR-582, BR-5824, BR-5825, STC3-149, especially wherein 66-100% of the oligomer component is BR-582, are polyether-backbone aliphatic urethane acrylates, from Bomar Specialties, Winsted, Conn.

5. RX 01203, RX 01099, RX 01336, RX 01071, RX 01218, IRR 245, EBECRYL 8800, EBECRYL 270, and EBECRYL 4826 oligomers, are from UCB Chemicals Corporation, Smyrna, Ga., all aliphatic urethane diacrylate oligomers based on polyethers.

EBECRYL 8800 oligomer is diluted 10% with ethoxyethoxyethyl acrylate; has a viscosity at 65 C of 8,000-18,000 cps and a Gardner Color Index of 2 max. Its density is 8.75 pounds per gallon. Its theoretical molecular weight is 1,700. When cured it has a tensile strength of 3,150 psi; a tensile elongation of 83%, and a glass transition temperature of 48° C.

EBECRYL 270 oligomer, previously sold as EBECRYL 4826 oligomer, contains no diluent monomer; has a viscosity of 2,500-3,500 cps at 60 C and a Gardner Color Index of 2 max. Its density is 8.91 pounds per gallon. Its theoretical functionality is 2 and its theoretical molecular weight is 1,500. When cured it has a tensile strength of 1,200 psi, a tensile elongation of 87% and a glass transition temperature of −27° C.

Methacrylate equivalents of these oligomers may also be used.

6. UVITHANE ZL-1178 oligomer from Morton Thiokol, Inc., Morton Chemical Division, Princeton, N.J., polyether based aliphatic urethane acrylate. This oligomer has a viscosity of 55-75 poises at 120° F. and 700-800 poises at 78° F. and, when cured neat, has a tensile strength of 325 psi and an ultimate elongation of 45%.

The methacrylate analog of this monomer may be used as well.

7. EBECRYL 4842, which is a silicone-modified polyether-based aliphatic urethane acrylate, sold neat, and EBECRYL 19-6264, which is not silicone-modified, but which is a polyether-based aliphatic urethane acrylate and which contains about 15% by weight of 1,6-hexanediol diacrylate as a reactive solvent, are from UCB Chemicals Corporation, Smyrna, Ga.

8. Hydrocarbon polyol-based aliphatic urethane acrylate oligomers such as are disclosed in U.S. Pat. No. 5,146,531, to Shustack. The content of that patent is expressly incorporated herein by reference. These oligomers are based on a linear or branched hydrocarbon polymer of from 600 to 4,000 molecular weight such as fully or partially hydrogenated 1,2-polybutadiene; 1,2-polybutadiene hydrogenated to an iodine number of from 9 to 21; and fully or partially hydrogenated polyisobutylene.

9. Polyether polyol-based oligomer of U.S. Pat. No. 5,527,835 to Shustack is also acceptable for use in making coating and is incorporated herein by reference in its entirety.

10. Furthermore, any aliphatic urethane acrylate oligomer of the type exemplified above is believed to be suitable so long as the desirable properties of the claimed fibers, coatings, methods and compositions are not adversely effected.

B. Polyester Acrylate

The polyester acrylate oligomer also useful as a base oligomer is preferably made by the condensation of acrylic acid with hydroxyl groups on a polyol or polyester backbone or hydroxy acrylate with residual acid groups on a polyester structure.

C. Acrylic Acrylate

The acrylic acrylate oligomer also useful as a base oligomer preferably comprises at least one radiation-curable (meth)acrylate group, and preferably, at least one acrylate group. These are known in the art as acrylated acrylics. The invention is not believed to be limited by how the acrylated acrylic oligomer, or any other oligomer, is prepared. Oligomer synthetic routes for acrylated acrylics can, for example, involve an esterification of a hydroxyl functional acrylic oligomer with (meth)acrylic acid, or the reaction of an epoxy-functional acrylic oligomer with (meth)acrylic acid. These acrylated acrylics can include urethane linkages. Acrylated acrylics can be prepared by known synthetic methods including, for example, (1) partial esterification of acrylic polymers having pendant carboxylic acid group with hydroxyethyl acrylate or glycidyl methacrylate, or in the alternative, acrylation of glycidyl methacrylate terpolymer with acrylic acid, or (2) polymerization of monomers which already have acrylate groups such as, for example, allyl methacrylate or N,N-dimethyl amino ethyl methacryl ate. The acrylic oligomer typically will have a copolymeric backbone. The glass transition temperature (Tg) of the oligomer can be lowered by decreasing the content of methyl methacrylate.

II. Polyfunctional Acrylate Di-Terminated Diphenylmethane Polyol Oligomer

The polyfunctional acrylate di-terminated diphenylmethane polyol oligomer in some instances may be termed an epoxy oligomer. However, an epoxy oligomer is an epoxy only in the sense that it is related in structure or function to compounds made of or from epoxies and acrylates or epoxy acrylates. Strictly speaking, the “epoxy oligomer” of the invention is a misnomer. Rather, the epoxy oligomer typically comprises polyfunctional polyacrylated bisphenol diglycidyl ethers, which are preferably the reaction product of a halohydrin and a bisphenol, more preferably bisphenol A.

Polyglycidyl ethers of aliphatic polyols are known for use as epoxy resin diluents. In general, they have low viscosity, with two or more epoxy groups in the molecule. Specific examples of such polyglycidyl ethers of aliphatic polyols include polyglycidyl ethers of 1,6-hexanediol, neopentylglycol, and trimethylolpropane and the like. However, such glycidyl ethers do not impart sufficient flexibility to the epoxy resin.

The inventors have unexpectedly found that these acrylated diglycidyl ether reaction products of bisphenols and halohydrins may impart sufficient flexibility, increased Tg and higher modulus to render them practical in fiber coating applications. Typically they are acrylate diterminated, polyhydroxylated and contain diphenylmethane groups. This finding is unexpected in light of the longstanding perception in the art that epoxy-type acrylates, which are in some ways structurally related to the inventive polyol oligomers, are unfit to serve functions like those of the base resin. For example, U.S. Pat. No. 5,639,846 to Shustack states in regard to the base resin that: “[a]crylated epoxies have unacceptable thermal and oxidative stability problems and are prone to yellowing.”

The polyol oligomers are preferably derived from bisphenol diglycidal ethers, which are preferably the reaction product of a halohydrin and a bisphenol, preferably bisphenol-A. This reaction product is then polyacrylated to form a polyfunctional acrylate di-terminated diphenylmethane polyol. Preferably the polyol is substituted with at least two hydroxyls, more preferably with at least three and with at least one of them a few atoms inside of each acrylate terminus. Still more preferably, the methane of the diphenylmethane has two methyl substituents and one of the phenyls of the diphenylmethane is about 0 to about 3 atoms away from an ester or partially saturated ester group.

For example, the compound having Formula II below is a diglycidyl ether reaction product of a bisphenol and a halohydrin:

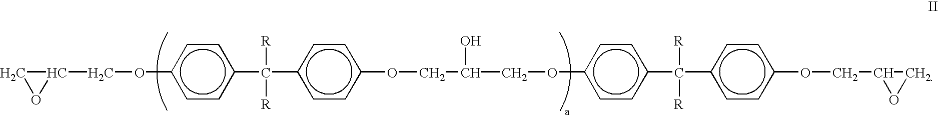

In Formula II, a is 0 to 4, preferably 0.5 to 3, typically 0, 1, 2, 3 or 4, R is hydrogen, methyl or linear or branched lower alkyl having 1 to about 6 carbon atoms, typically 1 to 4 carbon atoms, e.g., 1 or 2 carbon atoms. Examples of R include methyl, ethyl, propyl, isopropyl, butyl, isobutyl, tert-butyl, pentyl, isopentyl, hexxyl and the like and the R on one side may be the same or different from the R opposite. Typically, one or each R is methyl.

Typical acrylates and methacrylates, which may endcap the oligomer, include hydroxyethyl acrylate, hydroxyethyl methacrylate, hydroxypropyl acrylate, hydroxypropyl methacrylate, hydroxybutyl acrylate, hydroxybutyl methacrylate, and so forth. A preferred endcapping acrylate group is hydroxyethyl acrylate.

When reacted with a reactive moiety selected from the group consisting of acrylic, methacrylic, vinylic, allylic, styrenic, acrylamide, norbornenyl, acetylenic, epoxy, mercapto, amino, itanoic and crotonic moieties this compound may form an exemplary epoxy oligomer of the present invention, as depicted by Formula I. Suitable endcapping R′ moieties also include those discussed above for the encapping monomer (iii) of the urethane oligomer.

When acrylated with CH₂CHCOO— at each termini, this compound may form an exemplary epoxy oligomer of the present invention, as depicted by Formula IA below:

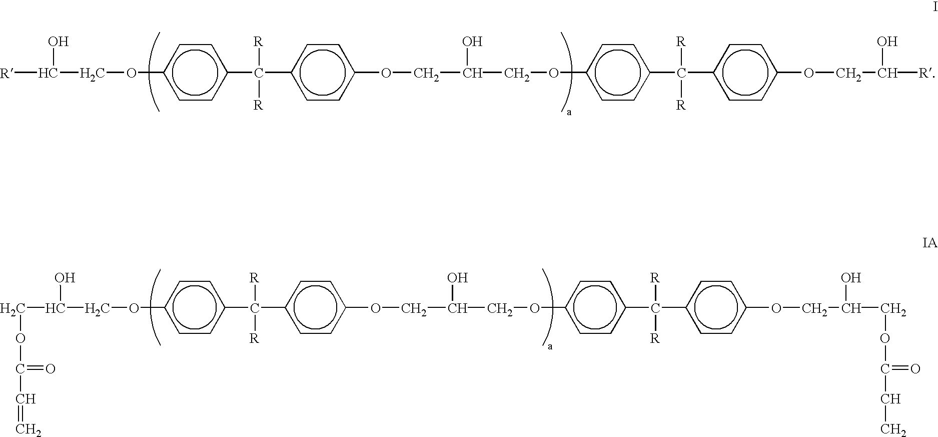

In Formula I R′ is a reactive moiety independently selected from the group consisting of acrylic, methacrylic, vinylic, allylic, styrenic, acrylamide, norbomenyl, acetylenic, epoxy, mercapto, amino, itanoic and crotonic moieties. Suitable endcapping R′ moieties also include those discussed above for the encapping monomer (iii) of the urethane oligomer. In both Formulas I and Ia, a is 0 to 4, preferably 0.5 to 3, typically 0, 1, 2 3 or 4 and, as described above, R is methyl or lower alkyl, and the R on one side may be the same or different from the opposite R.

Further examples of, and methods of preparing, bisphenol diglycidyl ethers are disclosed in U.S. Pat. No. 5,075,356 to Crosby et al, entitled Bisphenol and Neopentyl Glycol Diglycidyl Ethers with Glycidyl Methacrylate Copolymer; U.S. Pat. No. 6,048,956 to Muto et al, entitled Diglycidyl Ethers; U.S. Pat. No. 4,255,302 to Adams et al, entitled Resin System for Filament Winding of Pressure Vessels; U.S. Pat. No. 4,101,693 to Tsen et al entitled Method of Preparing Epoxy-Glass Prepegs; and U.S. Pat. No. 4,309,473 to Minamisawa et al, entitled Non-Tacky Strand Prepeg Comprising a Resin Composition. Adams et al and Tsen et al specifically disclose diglycidyl ethers that are the reaction product of bisphenol A and epichlorohydrin. Each of the foregoing patents is incorporated herein by reference in its entirety. Bisphenol A diglycidyl ether is also commercially available as EPICOAT 828 (Yuka Shell Epoxy Co. Ltd.) and DER 332.RTM resin (Hi-Tek Polymers) and XU71790.04L (Dow Chemical Company).

Compounds that are also considered within the scope of the invention include bisphenol A derivatives. Bisphenol A derivatives means that the phenolic groups of bisphenol A have been further functionalized so the hydroxyl moiety is no longer present. Conventional derivatives can be used, and commercially available derivatives have been found to be suitable.

III. Reactive Diluent Monomer

The typical function of the third component (reactive diluent) is to dilute the other oligomers to reduce their viscosity so that the liquid mixture may be smoothly applied to an optical fiber. The monomer diluent component should be reactive with the above-described oligomers, and preferably has one or more acrylate or methacrylate moieties per monomer. The monomer diluent may be capable of lowering the Tg (glass transition temperature) of the cured composition including it, and of lowering the viscosity of the uncured (liquid) composition to within the range of about 1,000 to about 10,000 cps (centipoises) at 25° C., preferably about 4,000 to about 8,000 cps, as measured by a Brookfield viscometer, Model LVT, spindle speed #34, at 25° C. If a viscosity higher than about 10,000 cps results, the liquid (uncured) composition including it may still be useful if certain processing modifications are effected (e.g., heating the dies through which the liquid coating composition is applied).

The monomer diluent comprises about 10 to about 80 percent, preferably about 15 to about 70 percent, and more preferably about 20 to about 65 percent by weight of the uncured (liquid) composition, based on the total weight of the composition (all ingredients). If less than about 10 percent of the monomer is present, viscosity may, again, be too high. Conversely, if more than 80 percent is present, viscosity would be too low.

Suitable examples of monomer diluents include, but are not limited to, aromatic-containing monomers such as phenoxyalkyl acrylates or methacrylates (e.g., phenoxyethyl(meth)acrylate); phenoxyalkyl alkoxylate acrylates or methacrylates (e.g., phenoxyethyl ethoxylate(meth)acrylate or phenoxyethyl propoxylate(meth)acrylate); paracumylphenol ethoxylated (meth)acrylate; 3-acryloyloxypropyl-2-N-phenylcarbamate; or one of any other such monomer diluents known to adjust the refractive index of a composition including it. Combinations including one or more of these are suitable as well. Such monomer diluents belonging to the later category are disclosed and described in U.S. Pat. No. 5,146,531 to Shustack herein incorporated by reference and may, for example, contain (1) an aromatic moiety; (2) a moiety providing a reactive (e.g., acrylic or methacrylic) group; and (3) a hydrocarbon moiety.

Samples of aromatic monomer diluents additionally containing hydrocarbon character and a vinyl group include but are not limited to polyalkylene glycol nonylphenylether acrylates such as polyethylene glycol nonylphenylether acrylate or polypropylene glycol nonylphenylether acrylate; polyalkylene glycol nonylphenylether methacrylates such as polyethylene glycol nonylphenylether methacrylate or polypropylene glycol nonylphenylether methacrylate; and mixtures of these.

Such monomers are, for example, available from Toagasei Chemical Industry Company, Ltd., Tokyo, Japan under the trade names ARONIX M110, M111, M113, M114, and M117, and from Henkel Corporation, Ambler, Pa., under the trade name PHOTOMER 4003. Especially M114, i.e., nonyl phenol 8 (EO) acrylate is preferred.

Other suitable monomer diluents additionally include hydrocarbon alkyl acrylates or methacrylates which are either straight chain or branched, and may contain 8 to 18 carbon atoms in the alkyl moiety such as hexyl acrylate; hexyl methacrylate; ethylhexyl acrylate; ethylhexyl methacrylate; isooctyl acrylate; isooctyl methacrylate; octyl acrylate; octyl methacrylate; decyl acrylate; decyl methacrylate; isodecyl acrylate; isodecyl methacrylate; lauryl acrylate; lauryl methacrylate; tridecyl acrylate; tridecyl methacrylate; myristyl acrylate; myristyl methacrylate; palmitic acrylate; palmitic methacrylate; stearyl acrylate; stearyl methacrylate; cetyl acrylate; cetyl methacrylate; C14-C15 hydrocarbon diol diacrylates; C14-C15 hydrocarbon diol dimethacrylates; and mixtures of the above. Of these, cetyl, lauryl and stearyl acrylates or methacrylates are most desired.

Also suitable are cyclic monomers such as isobornyl acrylate; isobornyl methacrylate; dicyclopentenyl acrylate; dicyclopentenyl methacrylate; dicyclopentenyl ethoxylate acrylate; dicyclopentenyl ethoxylate methacrylate; tetrahydrofurfuryl acrylate; tetrahydrofurfuryl methacrylate; and mixtures thereof. Also suitable is TONE M-100 monomer, a caprolactone acrylate available from Union Carbide Corp., Danbury, Conn., GENORAD 1122 monomer available from Hans Rahn, Zurich, Switzerland, which is 2-propenoic acid, 2-(((butyl)amino)carbonyloxy)ethylester, and N-vinyl caprolactam.

Monomers which are unsuitable include hydrophilic ones such as n-vinyl pyrrolidone and n-vinyl formamide. N-vinyl pyrrolidone, has in the past been widely used in optical fiber coating applications. However, it is particularly undesirable because it is hydrophilic and, on long term water soaking, confers very poor water resistance. Moreover, it has been found to be carcinogenic. Thus, the composition should be substantially free of these monomers.

Preferred monomers include the refractive-index modifying type monomers as disclosed herein, alone or in combination with an alkyl (meth)acrylate such as lauryl acrylate.

V. Photoinitiator

The necessity for this component depends on the envisioned mode of curing. If ultraviolet, a photoinitiator is needed. If by an electron beam, the material may comprise substantially no photoinitiator.

In the ultraviolet cure embodiment, the photoinitiator must provide reasonable cure speed without causing premature gelation of the mixed ingredients. Further, it must not interfere with the optical clarity of the cured coating. Still further, the photoinitiator must itself be thermally stable, non-yellowing, and efficient.

Suitable photoinitiators include, but are not limited to, the following:

2,4,6 trimethylbenzoyl diphenylphosphine-oxide;

bis(2,6-dimethoxybenzoyl)-2,4,4-trimethylpentyl-phosphine oxide;

1-hydroxycyclohexylphenyl ketone;

2-benzyl-2-dimethylamino-1-(4-morpholinophenyl)-butan-1-one;

2,2-dimethoxy-2-phenylacetophenone;

2-methyl-1-(4-(methylthio)phenyl)-2-(4-morpholinyl)-1-propanone;

2-hydroxy-2-methyl-1-phenyl propan-1-one;

4-(2-hydroxyethoxy)phenyl-2-hydroxy-2-propyl ketone;

1-(4-isopropylphenyl)-2-hydroxy-2-methylpropan-1-one;

1-(4-dodecyl-phenyl)-2-hydroxy-2-methylpropan-1-one;

4-(2-hydroxyethoxy)phenyl-2(2-hydroxy-2-propyl)-ketone;

2,2-di-sec-butoxyacetophenone;

diethoxyacetophenone;

diethoxyphenyl acetophenone;

a mixture of (2,6-dimethoxy benzoyl)-2,4,4 trimethylpentylphosphineoxide and 2-hydroxy-2-methyl-1-phenyl-propan-1-one;

1-propanone, 2-methyl-1-1-(4-(methylthio)phenyl) 2-(4-morpholinyl); and

mixtures of these.

Preferably, a benzoyl diaryl phosphine oxide type photoinitiator is present, such as 2,4,6 trimethylbenzoyl diphenylphosphine-oxide or bis(2,6-dimethoxybenzoyl)-2,4,4-trimethylpentyl-phosphine oxide. For an enhanced cure speed, a benzoyl diaryl phosphine oxide type photoinitiator can be combined with other photointitiators, such as 1-hydroxycyclohexylphenyl ketone.

A typical class of photoinitiators are the triacylphosphine oxides, such as trimethylbenzoyldiphenyl-phosphine oxide (available from BASF Corp., Chemicals Division, Charlotte, N.C. as LUCIRIN TPO), trimethylbenzoylethoxyphenylphosphine oxide (available from BASF as LUCIRIN 8893); bis-(2,6-dimethoxybenzoyl)-2,4,4-trimethylpentyl phosphine oxide (available from Ciba-Geigy Corp., Ardseley, N.Y.); bis-(2,6-dimethoxybenzoyl)-2,4,4-trimethyl pentyl phosphine oxide (sold as a component of CGI 1700 or CGI 1800 available from Ciba-Geigy Corp., Ardseley, N.Y.); bis-(2,4,6-trimethylbenzoyl) phenylphosphine oxide; and mixtures thereof. The BASF phosphine oxides marketed as LUCIRIN TPO and LUCIRIN 8893, alone or, particularly, in combination, are preferred.

The photoinitiator, when used in a coating, preferably comprises from about 0 percent to about 10 percent by weight of the uncured mixture, based upon the weight of the total mixture. Preferably, the amount of photoinitiator is from about 1 percent to about 5 percent. Any of the acceptable photoinitiators disclosed above are suitable. However, a lower level of photoinitiator is generally desirable in the secondary coating relative to the primary coating. The reason is that to cure the primary coating through the secondary coating, there must not be too much photoinitiator in the secondary coating blocking the light, as can occur where the coatings are applied wet-on-wet and then simultaneously cured. The photoinitiator should be used at a level such that a cure speed, as measured in a dose versus modulus curve, of less than 0.7 J/Cm², and preferably less than 0.5 J/cm², is obtained.

V. Adhesion Promoter

Optionally included in the ingredients that make up the primary coating layer is an adhesion promoter. Adhesion is a particularly pertinent problem in high humidity and high temperature environments, where delamination is more of a risk. For uses not protected from such environments, an adhesion promoter may be required.

It is known in the art to use either acid-functional materials or organofunctional silanes to promote adhesion of resins to glass. Silanes tend to be much more suitable in terms of these factors and, therefore, are the adhesion promoters of choice. Additionally, it is useful to have an adhesion promoter having a functionality which binds in with the system during cure, again to minimize the quantities of unbound volatiles. Various suitable organofunctional silanes include but are not limited to acrylate-functional silanes; amino-functional silanes; mercapto-functional silanes; methacrylate-functional silanes; acrylamido-functional silanes; allyl-functional silanes; and vinyl-functional silanes. The adhesion promoters preferably are methoxy- or ethoxy-substituted as well. Preferred organofunctional silanes include but are not limited to mercaptoalkyl trialkoxy silane, (meth)acryloxyalkyl trialkoxy silane, aminoalkyl trialkoxy silane, mixtures thereof, and the like. Methacrylated silanes are desirable, because they bind well with the cured system. However, they tend to slow the cure speed of the system. The mercapto-functional adhesion promoters also chemically bind in during cure, but do not appreciably slow down the cure speed of the system.

Some preferred organofunctional silanes that enhance adhesion in humid conditions include 3-acryloxypropyltrimethoxy silane, vinyl-tris(2-methoxyethoxysilane), 3-methacryloxypropyltrimethoxy silane, 3-aminopropyltriethoxy silane, 3-mercaptopropyl trimethoxy silane and 3-mercaptopropyl triethoxy silane, and mixtures thereof. A particularly preferred adhesion promoter is 3-acryloxypropyltrimethoxy silane.

The silane component comprises from about 0.05 percent to about 10, 5 or 3 percent by weight of the ingredients, typically 0.1 to 3.0, based on total weight of all ingredients. Preferably, the silane comprises from about 0.2 percent to about 2.0 percent, and more preferably from about 0.3 percent to about 1.0 percent, based on the total weight of the ingredients.

The following bis-silyl amines, diacrylated tertiary amine silanes, acetoxy functional silanes and trifunctional isocyanurate silanes are also suitable adhesion promoters.

A. Bis-silyl Amines

If desired, the silane component from about 0.05 to about 3.0 weight percent adhesion promoter, based on total weight of all ingredients, comprising one or more bis-silyl: These bis-silyl adhesion promoters have a Formula III:

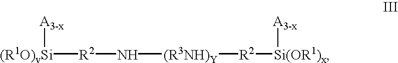

wherein each R¹ is independently C1-C4 alkyl, preferably C1 or C2 alkyl;

wherein each A is independently selected from the group consisting of C1-C15 alkyl, preferably C1-C4 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl;

each R² group is independently selected from the group consisting of C1-C15 alkyl, preferably C1-C4 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl; and C12-C15 substituted or unsubstituted bis-cyclic hydrocarbon, e.g., bis-phenol A radical;

each R³ is independently selected from the group consisting of C1-C15 alkyl, preferably C1-C4 alkyl, typically C2 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl; and C12-C15 substituted or unsubstituted bis-cyclic hydrocarbon, e.g., bis-phenol A radical;

X is 1 to 3;

V is 1 to 3; and

Y is 0to 1,

with the proviso that when the adhesion promoter contains bis(trimethoxysilyl)propylamine the coating composition (i) is free of oligomer having a saturated aliphatic backbone between at least two of the terminal ends with at least one epoxide group and/or (ii) comprises at least one adhesion promoter selected from the group consisting of a bis-silyl amines other than trimethoxysilylpropyl amine, diacrylated silane tertiary amine, acetoxy functional silanes, and trifunctional isocyanurates.

Typically, when the adhesion promoter contains bis(trimethoxysilyl)propylamine the coating composition (i) is free of oligomer having a saturated aliphatic backbone between at least two of the terminal ends with at least one epoxide group and/or (ii) comprises at least one adhesion promoter selected from the group consisting of a bis-silyl amines other than trimethoxysilylpropyl amine, diacrylated silane tertiary amine, acetoxy functional silanes, and trifunctional isocyanurates other than tris[(trimethoxysilyl)propyl]-isocyanurate.

Bis(trimethoxysilyl)propylamine has the formula (CH₃O)₃SiCH₂CH₂CH₂—NH—CH₂CH₂CH₂Si(OCH₃)₃ and information on this compound is presented in TABLE 2.

TABLE 2

| Compound (CAS#) | Structure | Suppliers |
|---|---|---|
| Bis(trimethoxysilyl) | (CH₃O)₃SiCH₂CH₂CH₂—NH—CH₂CH₂CH₂Si(OCH₃)₃ | Gelest (SIB1833.0) |
| propylamine | | |
| (82985-35-1) | | |

The coating layer may contains about 0.05 to about 30, typically about 0.1 to about 10, or about 0.2 to about 5, weight percent one or more bis-silyl amine adhesion promoters, based on total weight of all ingredients.

Typically, the primary coating layer contains from about 0.05 to about 5.0, for example from about 0.1 to about 3.0, or from about 0.2 to about 1.0, weight percent of one or more bis-silyl amine adhesion promoters based on the total weight of all ingredients.

B. Diacrylated Tertiary Amine Silanes

A family of diacrylated tertiary amine silanes has the following Formula IV.

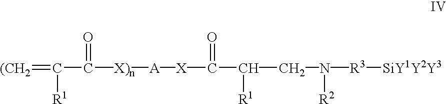

wherein R¹ is H or CH₃; n is 1 to 2; A is a bivalent linking group; X is O, S, NH; R2 is H or a C1-C20 organic group; R3 is a divalent linking group; and each of Y¹ Y² Y³ which may be the same or different, represents alkoxyl, carboxy alkoxy ether, alkyl or aryl. Methods of making these compounds are disclosed in published Patent Cooperation Treaty application no. WO 98/28307 incorporated herein by reference. In general, these compounds may be made by reacting a multifunctional (meth)acrylate of formula (V) with a silane of formula VI:

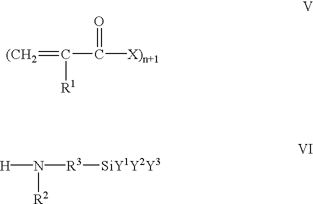

The coating layer may contain about 0.05 to about 10, typically about 0.1 to about 10, or about 0.2 to about 5, weight percent one or more diacrylated tertiary amine silanes adhesion promoters, based on total weight of all ingredients.

Typically, the primary coating layer contains from about 0.05 to about 5.0, for example from about 0.1 to about 3.0, or from about 0.2 to about 1.0, weight percent of one or more diacrylated tertiary amine silanes adhesion promoters based on the total weight of all ingredients.

The diacrylated tertiary amine silanes may include the amine listed in TABLE 3.

TABLE 3

| Compound (CAS#) | Structure | Suppliers |
|---|---|---|
| Diacrylated silane based | Proprietary | Sartomer |
| on tertiary amine | | (NTX4456) |

If desired, the amines of Formula IV, e.g., Sartomer (NTX4456 diacrylated tertiary amine silane), may be used in the presence or absence of the bis-silyl amines.

C. Acetoxy Functional Silanes

Another class of adhesion promoters are acetoxy functional silanes. If desired the acetoxy functional silanes may be used in the presence or absence of the bis-silyl amines.

Typical acetoxy functional silanes have the Formula VII.

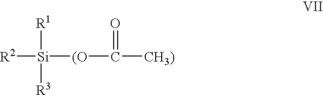

wherein R¹ and R² are independently selected from the group consisting of

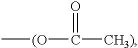

H, C1-C4 alkyl, phenyl, cyclohexyl, CH₂═CH₂, acrylate and C1-C4 alkoxy; and

R³ is independently selected from the group consisting of

C1-C4 alkyl, phenyl, cyclohexyl, CH₂═CH₂, acrylate and C1-C4 alkoxy. Unexpectedly it has been found that certain compounds of Formula VII are attractive adhesion promoters yet do not have free radical reaction with the radiation curable pre-polymer, namely those wherein R¹, R² and R³ do not contain a carbon to carbon double bond. The coating layer may contain about 0.05 to about 30, typically about 0.1 to about 10, or about 0.2 to about 5, weight percent one or more acetoxy functional silanes adhesion promoters, based on total weight of all ingredients.

Typically, the primary coating layer contains from about 0.05 to about 5.0, for example from about 0.1 to about 3.0, or from about 0.2 to about 1.0, weight percent of one or more acetoxy functional silanes adhesion promoters based on the total weight of all ingredients.

A number of typical acetoxy functional silanes are shown in TABLE 4.

TABLE 4

| Compound (CAS#) | Structure | Suppliers |
|---|---|---|
| Vinyltriacetoxy- silane (4130-08-9) | 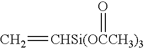 | Dow Corning (Z-6075), Gelest (SIV9098.0) |
| Dimethyldiacetoxy- silane (2182-66-3) | 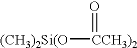 | Gelest (SID4076.0) |
| Vinylmethyl- diacetoxysilane (5356-85-4) | 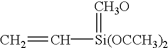 | Gelest (SIV9083.0) |
| Methyltriacetoxy- silane (4253-34-3) | 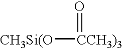 | Gelest (SIM6519.0) |

Additional typical acetoxy functional silanes are shown as follows:

DI-t-BUTOXYDIACETOXYSILANE

(Me₃ CO)Si(OCOCH₃)₂

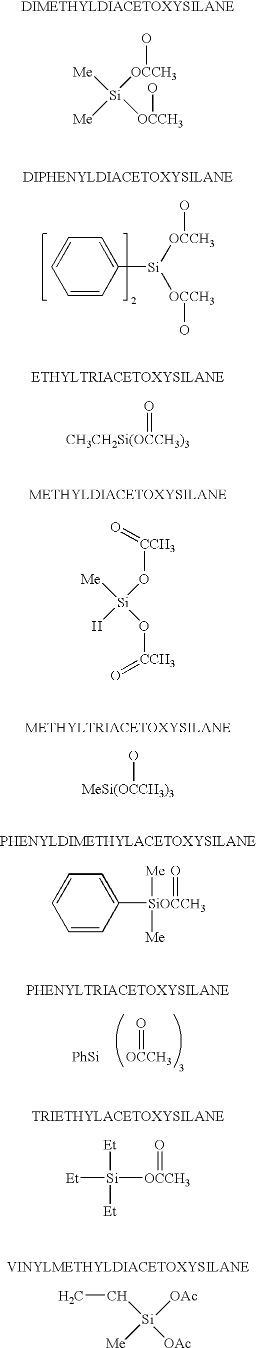

D. Trifunctional Isocyanurate Silanes

Another class of additional adhesion promoters are the trifunctional isocyanurates having a heterocyclic ring of 3 carbon atoms alternating with 3 nitrogen atoms, wherein each nitrogen atom is substituted with an R⁵ group and each R⁵ is independently selected from the group consisting of C1-C6 alkyl (typically C1, C2, C3 or C4 alkyl), vinyl, acetoxy, meth(acrylate), phenyl, cycloalkanes, and bis-phenyol A radical, and

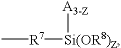

wherein R⁷ is C1-C6 alkyl, for example C3, C4, C5 or C6, R⁸ is C1-C4 alkyl, for example, C3 or C4, and Z is 1, 2 or 3, wherein at least one R⁵ is —R⁷— Si(OR⁸)z, and each A is independently selected from the group consisting of C1-C15 alkyl, preferably C1-C4 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl;

with the proviso that when the adhesion promoter contains tris[(trimethoxysilyl)propyl]-isocyanurate the coating composition (i) is free of oligomer having a saturated aliphatic backbone between at least two of the terminal ends with at least one epoxide group and/or (ii) comprises at least one adhesion promoter selected from the group consisting of bis-silyl amines, diacrylated silane tertiary amine, acetoxy functional silanes, trifunctional isocyanurates other than tris[(trimethoxysilyl)propyl]-isocyanurate.

Typically, when the adhesion promoter contains tris[(trimethoxysilyl)propyl]-isocyanurate the coating composition (i) is free of oligomer having a saturated aliphatic backbone between at least two of the terminal ends with at least one epoxide group and/or (ii) comprises at least one adhesion promoter selected from the group consisting of bis-silyl amines other than bis(trimethoxysilyl)propylamine, diacrylated silane tertiary amine, acetoxy functional silanes, trifunctional isocyanurates other than tris[(trimethoxysilyl)propyl]-isocyanurate. The coating layer may contain about 0.05 to about 30, typically about 0.1 to about 10, or about 0.2 to about 5, weight percent one or more trifunctional isocyanurate silane adhesion promoters, based on total weight of all ingredients.

Typically, the primary coating layer contains from about 0.05 to about 5.0, for example from about 0.1 to about 3.0, or from about 0.2 to about 1.0, weight percent of one or more trifunctional isocyanurate silane adhesion promoters based on the total weight of all ingredients.

An example of a trifunctional isocyanurate is tris[(trimethoxysilyl)propyl]-isocyanurate, having 3 identical R⁵ groups in which R⁷ is C3 alkyl, and R⁸ is methyl.

A typical trifunctional silane is shown in TABLE 5.

TABLE 5

| Compound | Structure | Supplier |
|---|---|---|
| Tris[(trimethoxysi propyl]- isocyanurate | 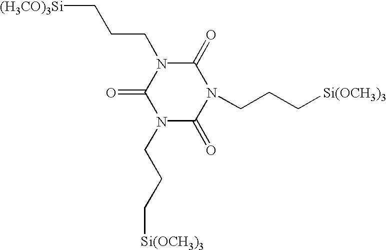 | Crompton (Y-11597) |

E. Adhesion Promoters Which Do Not Undergo Free Radical Reaction

Surprisingly, it has been discovered that silanes which did not couple with the coating polymer backbone could be useful for improving adhesion to glass. The conventional understanding for adhesion promoters was that one end of the coupling agent, the silanol group, would react with the glass and the other functional group of the coupling agent should react with the polymer matrix, hence the use of mercapto-, acrylo-, or methacrylo- silanes in prior art. For example, the compounds of Formula I, such as, bis(trimethoxysilyl)propylamine, would not be expected to have a free-radical reaction with the pre-polymer because they have no free radical polymerizable groups. Also, dimethyldiacetoxy silane, epoxy functional silanes, and tris[(trimethoxysilyl)propyl]-isocyanurate and mixtures thereof would not be expected to have a free-radical reaction with the pre-polymer because they have no free radical polymerizable groups. Unexpectedly it has been found that certain acetoxy functional silane compounds of Formula VII are attractive adhesion promoters yet do not have free radical reaction with the radiation curable pre-polymer, namely those wherein R¹, R² and R³ do not contain a carbon to carbon double bond.

V. Stabilizer

To improve shelf life (storage stability) of the uncured coating mixture, as well as to increase thermal and oxidative stability of the cured coating layer, one or more stabilizers may be added. Examples of suitable stabilizers include tertiary amines such as diethylethanolamine and trihexylamine, hindered amines, organic phosphates, hindered phenols, mixture thereof, and the like. Some particular examples of antioxidants which can be used include octadecyl-3-(3′,5′-di-tert-butyl-4′-hydroxyphenyl) propionate, thiodiethylene bis (3,5-di-tert-butyl-4-hydroxy) hydrocinnamate, and tetrakis (methylene (3,5-di-tert-butyl-4-hydroxyhydrocinnamate)) methane. Additionally, certain silanes in small quantities, e.g., as low as 0.0001 percent to 0.1 percent by weight, may be used as stabilizers. An example of suitable such silane is 3-aminopropyl trimethoxy silane.

When a stabilizer is used, it may be incorporated in an amount from about 0.0001 percent to about 3.0 percent, based on the weight of the mixture. Preferably, it is included in the range from about 0.25 percent to about 2.0 percent by weight, and more preferably in the range from about 0.5 percent to about 1.5 percent by weight, based on the total weight of all of the ingredients. Preferred stabilizers are thiodiethylene bis (3,5-di-tert-butyl-4-hydroxy) hydrocinnamate and 3-aminopropyl trimethoxysilane.

Another optional additive for the secondary coating is a surface tension adjusting silicone additive, which may be used in embodiments where a secondary coating is to be applied atop a cured primary coating.

Preparation of a Coated Optical Fiber

The invention also relates to a process for preparing a coated optical fiber.

Preferably, the process comprises applying to an optical glass fiber a coating reaction mixture comprising the following ingredients:

(A) from about 10 percent to about 90 percent by weight of a reactively terminated base oligomer, for example urethane oligomer which is the reaction product of (i) at least one polyol selected from the group consisting of polyether polyols, hydrocarbon polyols, polycarbonate polyols, and polyisocyanate polyols; (ii) a polyisocyanate; and (iii) an endcapping monomer supplying a reactive terminus;

(B) from about 5 percent to about 80 percent by weight of a polyol oligomer, the polyol oligomer comprising a bisphenol diglycidyl ether, the diglycidyl ether reaction product being terminated at both ends by a reactive moiety, for example an acrylate group, capable of reacting with the reactive terminus of (A);

(C) from about 10 percent to about 80 percent by weight of a reactive diluent; and

(D) from about 0 percent to about 10 percent by weight of a photoinitiator; and

wherein all of the stated percentages are percentages by weight based on the total weight of (A), (B), (C) and (D).

More preferably, the process comprises applying to an optical glass fiber a coating reaction mixture comprising the following ingredients:

(A) from about 40 to about 80 percent by weight of one or more base oligomers, for example acrylate- or methacrylate-terminated polyether urethane oligomers;

(B) from about 20 to about 50 percent by weight of a polyol oligomer, the polyol oligomer comprising a bisphenol diglycidal ether, the diglycidal ether reaction product being terminated on both ends by an acrylate group capable of reacting with the reactive terminus of the polyether urethane oligomers (A);

(C) from about 20 to about 65 percent by weight of a reactive diluent; and

(D) from about 1 to about 5 percent by weight of a photoinitiator; and wherein all of the percentages being percentages by weight based on the weight of ingredients (A), (B), (C) and (D).

Preferably, the coating ingredients for a secondary coating are selected for high tensile strength, high elongation to break, appropriate modulus, hydrolytic stability, and thermal stability. More preferably, the secondary coating material, prior to curing, has a freeze point, i.e., temperature of initiation of crystallization, of at most about 60° C., preferably at most about 25° C. The frozen particles formed at the freeze point may be visible with magnification or visible without magnification. Typically, the freeze point is in the range from about 0° to about 60° C., preferably from about 0° C. to about 25° C. To achieve these freeze points, preferably the combination of oligomers is liquid at 5 to 25° C., or at least a liquid at room temperature. Employing liquids facilitates mixing these ingredients. This liquid may be achieved by starting with liquid base oligomers. However, liquid mixtures may also be made from a solid oligomer where the solid oligomer liquefies upon mixing with the other oligomer, which is liquid. If the material freezes, it is not homogeneous. However, it may be returned to homogeneity by heating.

After mixing the ingredients and coating an optical fiber, the coating undergoes radiation-curing in situ. In one embodiment, the process comprises applying only the primary coating to the optical fiber and radiation-curing the coating in situ. In an alternative embodiment, a secondary coating may be applied atop the primary coating, and the two coatings sequentially or simultaneously radiation cured.

The primary and secondary coatings may be applied and cured by any method known in the art. A preferred method, whereby two coatings are applied wet-on-wet, is disclosed in U.S. Pat. No. 4,474,830 to C. Taylor of AT&T Bell Laboratories. The coating or coatings may then be cured in situ, preferably by ultraviolet irradiation, to obtain a cured polymeric coating. Alternatively, the primary coating may be applied and cured, after which the secondary coating may be applied and cured.

Optical Fiber Ribbon

The invention also relates to an optical fiber ribbon including the above-described optical fibers and coating. The invention also relates to an optical fiber ribbon including a matrix made of the above-described coating material. In making optical fiber ribbons, a plurality of the coated optical fibers described above is coated by a matrix that holds together the fibers. The matrix is a polymer material coated on the fibers and then cured. Where the coating of the present invention is embedded within the matrix, then the matrix may be made of a coating of the present invention or a conventional matrix. Typical known matrix materials are disclosed by U.S. Pat. No. 5,908,873 to Shustack, U.S. Provisional Patent Application No. 60/281,379 to Wilson, and by U.S. Patent Application No. ______, filed Apr. 4, 2002 (Attorney Docket No. APV 31664A) to Wilson, which are incorporated herein by reference in their entirety.

The matrix is made from a radiation-curable liquid matrix mixture. The matrix may be made from substantially the same ingredients that comprise the primary and secondary coatings described herein, provided that the mixture, when cured, has the following properties: moisture resistance; solvent resistance; extreme ease of stripping; resistance to breakout failure; low volatiles, extractables and exudate content; absence of particulate material; absence of components which are harmful to human beings or to the cured coating; fast cure when irradiated; and long term thermal, oxidative and hydrolytic stability. It should be non-yellowing. It must be somewhat hard-curing, must have a high elongation to break, and must have superb release properties. It must, when cured, be strippable from the underlying fibers without being dissolved and without removing ink from the underlying fibers. It should also be resistant to failure during “cabling”. Cabling is the term used to describe a process of gathering a plurality of the ribbons together to form a cable.

Buffering and Upjacket Materials

The invention also relates to buffering (e.g., buffer tubes) and upjacket materials, for coating one or more optical fibers, made of the above described coating material.

### EXAMPLES

The following Examples, having results listed in TABLE 6, serve to further illustrate the invention. In these Examples and elsewhere throughout this application, all parts and percentages are by weight of the total ingredients described in that Example, and all temperatures are in degrees centigrade unless expressly stated to be otherwise. The ingredients were mixed by standard techniques. In all of the Examples, cure doses were measured with an International Light IL 390C radiometer. All Examples employ ultraviolet cure.

Unless otherwise noted, throughout the Examples and the remainder of this specification, “modulus” refers to 2.5% tensile modulus, at 25° C., measured using an Instron Model 5565 tensile tester, per ASTM-D882. Stress and strain were also measured per ASTM-D882.

TABLE 6

| | | | | | | Modulus | Modulus | | | | | | | |
|---|---|---|---|---|---|---|---|---|---|---|---|---|---|---|
| | | | | | | @ 50 | @ 1000 | | | | | | Viscosity | Cure |
| | | | | | | mJ/cm² | mJ/cm² | Stress | Strain | Static | Kinetic | % RAU | @ 25 C | Ratio |
| Formula | CN983 | CN996 | CN120Z | HDODA | SR9003 | psi | psi | psi | % | CoF | CoF | % | (cps) | % |
| 1 | 0 | 20 | 33.45 | 13.45 | 15 | 61800 | 77800 | 3002 | 8 | 0.0775 | 0.0422 | 96 | 832 | 79 |
| 2 | 0 | 48.97 | 10 | 18.97 | 3.97 | 7581 | 18600 | 1113 | 18 | 0.0990 | 0.0593 | 100 | 1439 | 41 |
| 3 | 0 | 20 | 36.9 | 25 | 0 | 71633 | 114000 | 1848 | 3 | 0.0729 | 0.0376 | 98 | 807 | 63 |
| 4 | 0 | 40 | 10 | 16.9 | 15 | 8396 | 22300 | 815 | 11 | 0.1262 | 0.0608 | 100 | 630 | 38 |
| 5 | 13.83 | 25.45 | 17.17 | 14.84 | 10.61 | 45846 | 74200 | 2652 | 14 | 0.0736 | 0.0273 | 96 | 997 | 62 |
| 6 | 0 | 48.97 | 10 | 10 | 12.93 | 4739 | 7000 | 899 | 25 | 0.1298 | 0.0783 | 100 | 1916 | 68 |
| 7 | 0 | 33.45 | 23.45 | 10 | 15 | 19435 | 35700 | 1647 | 16 | 0.0861 | 0.0462 | 98 | 1361 | 54 |
| 8 | 0 | 46.9 | 10 | 25 | 0 | 10457 | 75700 | 1114 | 15 | 0.0734 | 0.0452 | 98 | 888 | 14 |
| 9 | 20 | 20 | 10 | 16.9 | 15 | 48113 | | 2532 | 8 | 0.0560 | 0.0248 | 98 | 481 | |
| 10 | 9.33 | 38.29 | 10 | 17.14 | 7.14 | 15369 | 30200 | 1570 | 18 | 0.0955 | 0.0440 | 97 | 967 | 51 |
| 11 | 7.93 | 50 | 10 | 13.97 | 0 | 11112 | 15600 | 1688 | 33 | 0.1003 | 0.0610 | 97 | 2849 | 71 |
| 12 | 0 | 50 | 21.9 | 10 | 0 | 11294 | 20100 | 1859 | 35 | 0.1280 | 0.0558 | 95 | 5463 | 56 |
| 13 | 0 | 31.9 | 40 | 10 | 0 | 45471 | 47000 | 2578 | 14 | 0.0562 | 0.0355 | 95 | 4729 | 97 |
| 14 | 6.8 | 40.45 | 18.42 | 13.11 | 3.11 | 22682 | 28200 | 1831 | 21 | 0.0875 | 0.0319 | 98 | 2700 | 81 |
| 15 | 0 | 40 | 10 | 16.9 | 15 | 6894 | 20800 | 1022 | 18 | 0.1010 | 0.0535 | 100 | 605 | 33 |
| 16 | 0 | 20 | 30 | 22.3 | 9.6 | 40036 | 83600 | 1749 | 5 | 0.0829 | 0.0325 | 97 | 389 | 48 |
| 17 | 0 | 40 | 10 | 25 | 6.9 | 8224 | 26800 | 975 | 14 | 0.1000 | 0.0412 | 100 | 487 | 31 |
| 18 | 20 | 31.9 | 10 | 10 | 10 | 31937 | 48500 | 2032 | 15 | 0.0603 | 0.0263 | 98 | 1857 | 66 |
| 19 | 13.33 | 20 | 28.57 | 20 | 0 | 66401 | | 2458 | 7 | 0.0518 | 0.0185 | 98 | 1186 | |
| 20 | 20 | 34.6 | 17.3 | 10 | 0 | 44460 | 59700 | 2922 | 29 | 0.0781 | 0.0275 | 97 | 4742 | 74 |
| 21 | 7.66 | 30.89 | 20.89 | 16.23 | 6.23 | 34493 | 65400 | 1984 | 9 | 0.0649 | 0.0311 | 97 | 1072 | 53 |
| 22 | 0 | 48.97 | 10 | 10 | 12.93 | 4664 | 10400 | 928 | 24 | 0.0969 | 0.0528 | 95 | 1765 | 45 |
| 23 | 0 | 23.97 | 40 | 13.97 | 3.97 | 57569 | 101000 | 2964 | 10 | 0.0777 | 0.0492 | 98 | 2265 | 57 |
| 24 | 0 | 33.45 | 23.45 | 10 | 15 | 19373 | 32500 | 1835 | 20 | 0.0996 | 0.0472 | 99 | 1324 | 60 |
| 25 | 20 | 20 | 16.9 | 10 | 15 | 58200 | 94300 | 2941 | 11 | 0.0739 | 0.0296 | 99 | 1280 | 62 |
| 26 | 0 | 40.95 | 30.95 | 10 | 0 | 23508 | 46800 | 1972 | 20 | 0.1003 | 0.0343 | 97 | 5457 | 58 |
| 27 | 17.3 | 27.3 | 27.3 | 10 | 0 | 52919 | 82300 | 2725 | 9 | 0.0780 | 0.0338 | 95 | 4826 | 64 |
| 28 | 11.9 | 20 | 40 | 10 | 0 | 82295 | 129700 | 3140 | 5 | 0.0649 | 0.0498 | 95 | 5790 | 63 |
| 29 | 13.33 | 20 | 28.57 | 10 | 10 | 57483 | 104100 | 2825 | 9 | 0.0518 | 0.0275 | 98 | 1613 | 55 |
| 30 | 6.67 | 26.67 | 16.67 | 25 | 6.9 | 27892 | 68600 | 1741 | 10 | 0.0607 | 0.0262 | 99 | 414 | 41 |
| 31 | 20 | 20 | 10 | 25 | 6.9 | 55322 | 105300 | 2522 | 6 | 0.0819 | 0.0308 | 96 | 404 | 53 |
| 32 | 6.67 | 20 | 25.63 | 25 | 4.6 | 54115 | 109300 | 2473 | 6 | 0.0654 | 0.0257 | | 501 | 49 |
| 33 | 6.67 | 20 | 23.33 | 16.9 | 15 | 56415 | 108400 | 2750 | 8 | 0.0518 | 0.0303 | 99 | 753 | 52 |
| 34 | 7.66 | 30.89 | 20.89 | 16.23 | 6.23 | 32455 | 61600 | 1968 | 11 | 0.1366 | 0.0614 | 98 | 1262 | 53 |
| 35 | 0 | 20 | 38.97 | 10 | 12.93 | 59627 | 114800 | 2245 | 7 | 0.0564 | 0.0149 | 96 | 1810 | 52 |
| 36 | 0 | 33.45 | 23.45 | 25 | 0 | 28500 | 55900 | 1807 | 10 | 0.1226 | 0.0326 | 97 | 974 | 51 |
| 37 | 20 | 20 | 10 | 25 | 6.9 | 49529 | 83250 | 2202 | 6 | 0.0876 | 0.0180 | 99 | 374 | 60 |
| 38 | 20 | 29.6 | 10 | 20 | 2.3 | 39456 | 67300 | 2282 | 11 | 0.0563 | 0.0152 | 98 | 864 | 59 |
| 39 | 20 | 20 | 21.9 | 15 | 5 | 70061 | 100000 | 3376 | 10 | 0.0873 | 0.0276 | 98 | 1341 | 70 |
| 40 | 0 | 20 | 30 | 22.3 | 9.6 | 45092 | 64900 | 2004 | 6 | 0.0736 | 0.0411 | 98 | 484 | 47 |
| 41 | 20 | 20 | 31.9 | 10 | 0 | 76565 | 128300 | 3245 | 7 | 0.0821 | 0.0425 | 93 | 4873 | 60 |
| 42 | 20 | 20 | 16.9 | 25 | 0 | 66094 | 100500 | 3075 | 6 | 0.0655 | 0.0175 | 97 | 674 | 66 |
| 43 | 3.83 | 25.45 | 27.17 | 14.84 | 10.61 | 34590 | 69300 | 2180 | 14 | 0.0609 | 0.0168 | 97 | 928 | 50 |
| 44 | 13.33 | 33.57 | 10 | 10 | 15 | 20339 | 41800 | 1605 | 15 | 0.0913 | 0.0381 | 98 | 1173 | 49 |
| 45 | 13.33 | 33.57 | 10 | 25 | 0 | 34383 | 60600 | 2091 | 12 | 0.1043 | 0.0289 | 99 | 792 | 57 |
| 46 | 7.93 | 50 | 10 | 10 | 3.97 | 8505 | 14400 | 1253 | 28 | 0.1190 | 0.0516 | 97 | 3718 | 59 |
| 47 | 20 | 41.9 | 10 | 10 | 0 | 28065 | 28800 | 2153 | 27 | 0.1098 | 0.0430 | 95 | 5038 | 97 |

The amounts of the above ingredients are listed in Table 2 in weight percent.

CN983 and CN996 are polyether urethane acrylates available from Sartomer Company, Exton, Pa.

CN120Z is an epoxy acrylate oligomer available from Sartomer Company, Exton, Pa.

HDODA refers to hexane diol diacrylate, available as SR238 from Sartomer Company, Exton, Pa.

SR9003 is propoxylated neopentyl glycol diacrylate available from Sartomer Company, Exton, Pa.

SR285 is tetrahydrofurfuryl acrylate available from Sartomer Company, Exton, Pa.

BYK371 and BYK3500 are modified silicone acrylates available from Byk-Chemie, USA.

The remainder of each formula of Table 2 contains the formula:

| | | |
|---|---|---|
| SR 285 | 10 | wt. % |
| Irgacure 184 | 3 | wt. % |
| Irgacure 907 | 2 | wt. % |
| Lucirin TPO | 1 | wt. % |
| Irganox 1035 | 1 | wt. % |
| Byk 37 1RP | 0.8 | wt. % |
| Byk 3500 | 0.3 | wt. % |

The values for the minimum degree of inside cure represent the percent reacted acrylate unsaturation (%RAU). They were determined by using FTIR-ATR (Fourier Transform Infrared Spectroscopy-Attenuated Total Reflectance) to analyze samples of the matrix material, as cured on a 6 mm glass plate with a radiation dose of about 0.2 J/cm². The method was used to determine the %RAU using a Nicolet Magna FTIR bench with Continuum microscope and a Spectra Tech Infinity Series diamond ATR attachment is described below.

The Nicolet Magna 860 was used with the following settings: number of scans=128; resolution=4; gain=4, velocity=1.89; aperture=100; beam splitter=KBr; and detector=MCT (mercury cadmium telluride). After the settings have been verified, a background spectrum is obtained by sliding the ATR objective into alignment slightly above the liquid sample.

Next, the uncured coating sample is prepared and the spectra obtained. For example, a single drop of liquid coating is placed on a slide. The drop is aligned below the crystal using a visual objective, then the ATR crystal is slid back to collect the spectrum. The stage is then raised until the spectrum appears on the screen. The spectrum is then collected, whereafter the stage is lowered and the diamond crystal is cleaned with methanol.

Then, a sample of the film prepared above is prepared and its spectrum is obtained. Such a sample is 100 microns thick, 80 mm wide and 120 mm long. The film is aligned using the visual objectives (15× Reflachromat) to get the sample close to the objective, whereafter the ATR crystal is swung underneath. The sample can then be generated and collected.

The measurement is completed by obtaining the peak areas. This may be accomplished by first, converting the liquid sample spectrum to absorbance, and using OMNIC software available from Nicolet, or any other method of calculating peak areas, calculating the areas under the peaks at 1410 cm⁻¹ and 1520 cm⁻¹ for both the liquid sample and the film sample.

Finally, the % RAU is calculated using the following formula:

$$[ \frac{area 1410 {cm}^{- 1} liquid}{area 1520 {cm}^{- 1} liquid} - \frac{area 1410 {cm}^{- 1} film}{area 1520 {cm}^{- 1} film} ] \div \frac{area 1410 {cm}^{- 1} liquid}{area 1520 {cm}^{- 1} liquid} \times 100$$

The samples were 100 microns thick, 80 mm wide and 120 mm long. The percent RAU was measured at the bottom surface of these samples. The curing unit used was a Fusion Systems with a 300 Watt/inch irradiator. A 9 millimeter diameter D bulb was used. The films were cured at a temperature of 25° C. allowed to condition for about 72 hours away from light at 50+/−10 percent RH and 23+/−2° C. However, in cases where materials other than acrylates are being cured, such as methacrylates or vinyls, the FTIR technique is modified for the particular peaks being monitored, but the resulting calculated percent reacted functional groups remain the same as used for acrylates.

The viscosity of the uncured (liquid) composition was measured by a Brookfield viscometer, Model LVT, spindle speed #34, at 25° C.

The coefficient of friction (CoF) values were measured in the following manner: Each film was drawn down onto a glass plate measuring 4″×7″×⅛″ using a 6 mil Bird Applicator with a 3-½-film width. The film was then cured with a Fusion ‘D’ lamp delivering a dose of 700 mJ/cm² as measured by an International Light IL390C Compact Radiometer in a chamber inerted with pre-purified grade nitrogen. The level of O₂ was less than 100 ppm as measured by an Omega Trace Oxygen Analyzer Series Y-115-BTP. Each film was then inspected for defects and any films exhibiting defects were discarded and another film prepared. The films were then conditioned at 50+/−2.5% RH and 23° C. +/−2° C. for 16 to 24 hours before testing.

The conditioned films were then tested using an Instron Tensile Tester, Model 5565 with COF testing apparatus available from Instron Corp attached. A 19.6500 N three ball sled was used at a testing speed of 200 mm/min. The film was pulled for two inches and Merlin Version 4.31 software calculated the static and kinetic coefficient of friction.

It should be apparent that many modifications may be made to the above-described embodiments while remaining within the spirit and scope of the present invention. Thus, the present invention is not limited by the above-described embodiments, but only by the claims appended hereto.

What is claimed is:

1. A coated optical fiber assembly comprising:
an optical fiber having one or more radiation-cured layers,
wherein at lease one layer is formed from a mixture of at least one base oligomer and at least one radiation-curable polyfunctional di-terminated diphenylmethane polyol oligomer,
wherein the base oligomer is selected from at least one member of the group consisting of a urethane acrylate oligomer, a polyester acrylate and an acrylic acrylate, and
wherein each terminus of the polyol oligomer is capped by a reactive moiety capable of reacting with reactive termini of the base oligomer and other polyol oligomers.

2. The assembly of claim 1, wherein the reactive moiety is selected from the group consisting of acrylic, methacrylic, vinylic, allylic, styrenic, acrylamide, norbornenyl, acetylenic, epoxy, mercapto, amino, itanoic and crotonic moieties.

3. The assembly of claim 1, wherein the polyol oligomer comprises from about 1 to about 5 diphenylmethane groups and the reactive moiety is an acrylate moiety.

4. The assembly of claim 3, wherein at least one diphenylmethane group is part of the main backbone of the polyol oligomer rather than a substituent thereon.

5. The assembly of claim 4, wherein all of the diphenylmethane groups are part of the main backbone of the polyol oligomer rather than substituents thereon.

6. The assembly of claim 5, wherein at least one diphenylmethane group is substituted.

7. The assembly of claim 6, wherein at least one diphenylmethane group is substituted by at least one alkyl group having 1 to about 6 carbons.

8. The assembly of claim 7, wherein the methane portion of at least one diphenylmethane group is substituted by at least one alkyl group having 1 to 4 carbons, and wherein the base oligomer comprises a urethane acrylate oligomer.

9. The assembly of claim 8, wherein the methane portion of at least one diphenylmethane group is substituted by 2 methyl groups.

10. The assembly of claim 9, wherein the methane portion of each diphenylmethane group is substituted by 2 methyl groups.

11. The assembly of claim 10, wherein the polyol oligomer comprises at least 2 hydroxy groups.

12. The assembly of claim 11, wherein the polyol oligomer comprises 2 to about 6 hydroxy groups.

13. The assembly of claim 12, wherein at least one diphenylmethane group is 0 to 1 carbon atoms away from an oxygen bridge atom that is 0 to 2 carbon atoms away from a hydroxy bearing carbon.

14. The assembly of claim 13, wherein each diphenylmethane group is 0 to 1 carbon atoms away from an oxygen bridge atom that is 0 to 1 carbon atoms away from a hydroxy bearing carbon.

15. The assembly of claim 14, wherein each diphenylmethane group is 0 carbon atoms away from an oxygen bridge atom that is 0 carbon atoms away from a hydroxy bearing carbon.

16. The assembly of claim 15, wherein each acrylate moiety is within 0 to 3 atoms of a hydroxy bearing carbon.

17. The assembly of claim 1, wherein the polyol oligomer is derived from a bisphenol diglycidyl ether.

18. The assembly of claim 17, wherein the polyol oligomer is derived from a reaction mixture of acrylate and a bisphenol A diglycidyl ether represented by the following Formula (I): 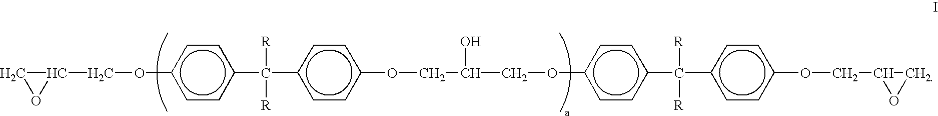
wherein a is 0 to about 4; wherein R is hydrogen, methyl or linear or branched lower alkyl having 1 to about 6 carbon atoms, and the R on one side may be the same or different from the opposite R; and derivatives thereof.

19. The assembly of claim 18, wherein a is 1 to 4 and each R is methyl.

20. The assembly of claim 1, wherein the polyol oligomer is represented by owing formula (I): 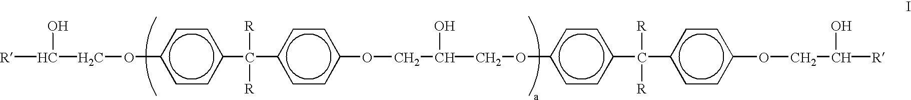
wherein R′ is a reactive moiety selected from the group consisting of acrylic, methacrylic, vinylic, allylic, styrenic, acrylamide, norbornenyl, acetylenic, epoxy, mercapto, amino, itanoic and crotonic moieties, and a is about 0 to about 4; wherein R is hydrogen, methyl or linear or branched lower alkyl having about 1 to about 6 carbon atoms, and the R on one side may be the same or different from the opposite R; and derivatives thereof.

21. The assembly of claim 1, wherein the polyol oligomer is represented by the following Formula (IA): 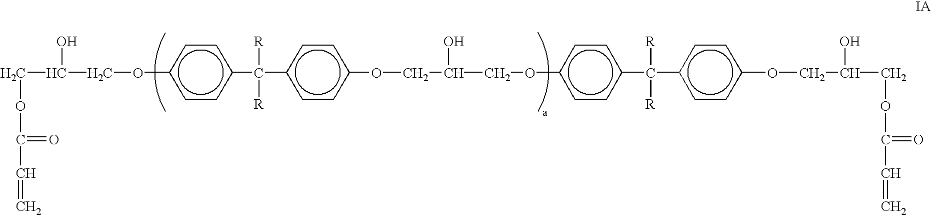
wherein a is about 0 to about 4; wherein R is hydrogen, methyl or linear or branched lower alkyl having about 1 to about 6 carbon atoms, and the R on one side may be the same or different from the opposite R; and derivatives thereof.

22. The assembly of claim 20, wherein a is 1 to 4 and each R is methyl.

23. The optical fiber of claim 22, wherein the bisphenol A diglycidyl ether is the reaction product of a bisphenol A and a halohydrin.

24. The assembly of claim 22, wherein the base oligomer comprises a urethane acrylate oligomer.

25. The assembly of claim 24, wherein the polyol oligomer comprises no more than two acrylate moieties.

26. The assembly of claim 1, wherein the layer comprises from about 10 weight percent to about 90 weight percent of the urethane acrylate oligomer, from about 5 weight percent to about 80 weight percent of the polyol oligomer, from about 10 weight percent to about 80 weight percent of a reactive diluent and from about 0 weight percent to about 10 weight percent of a photoinitiator.

27. The assembly of claim 26, wherein the layer comprises from about 40 weight percent to about 80 weight percent of the urethane acrylate oligomer, from about 20 weight percent to about 50 weight percent of the polyol oligomer, from about 20 weight percent to about 65 weight percent of the reactive diluent and from about 1 weight percent to about 5 weight percent of the photoinitiator.

28. The assembly of claim 1, wherein the layer exhibits a UV absorbance at 500 nm relative to distilled water of less than about 0.04.

29. The assembly of claim 28, wherein the layer exhibits a UV absorbance at 500 nm relative to distilled water of less than about 0.02.

30. The assembly of claim 1, wherein the base oligomer, and the polyol oligomer and reactive diluent are selected such that a mixture thereof is liquid at 5 to 25° C.

31. An assembly comprising a plurality of optical fibers of claim 1 and a matrix material, the plurality of fibers held together in a parallel arrangement by the matrix material.

32. The assembly of claim 1, wherein the layer is a primary coating of the optical fiber.

33. The assembly of claim 1, wherein the layer is a secondary coating of the optical fiber.

34. The assembly of claim 1, wherein the layer comprised of the polyol oligomer is both a primary and a secondary coating of the fiber.

35. The assembly of claim 1, wherein the layer is a matrix about the optical fiber.

36. The assembly of claim 1, wherein the layer is a matrix about the optical fiber.

37. The assembly of claim 1, wherein the layer is an upjacket about the optical fiber.

38. The assembly of claim 1, wherein the layer is a buffer layer about the optical fiber.

39. A composition for coating optical fibers comprising a mixture of the following ingredients:
(1) from about 10 to about 90 percent by weight of a base oligomer selected from at least one member of the group consisting of a urethane acrylate oligomer, a polyester acrylate and an acrylic acrylate;
(2) from about 5 to about 80 percent by weight of one or more radiation-curable polyfunctional di-terminated diphenylmethane polyol oligomers, said polyol oligomers being terminated on both ends by a reactive group capable of reacting with reactive termini of the base oligomer and other polyol oligomers;
(3) from about 10 percent to about 80 percent by weight of a reactive diluent;
(4) from about 0 to about 10 percent by weight of a photoinitiator; and
wherein all of said percentages by weight are based on the weight of all said ingredients.

40. The process of claim 39, wherein the reactive moiety is selected from the group consisting of acrylic, methacrylic, vinylic, allylic, styrenic, acrylamide, norbornenyl, acetylenic, epoxy, mercapto, amino, itanoic and crotonic moieties

41. The process of claim 39, wherein the base oligomer comprises one or more acrylate-terminated aliphatic polyether urethane oligomers, and the reactive moiety is an acrylate moiety.

42. The process of claim 39, wherein the reactive moiety is a methacrylate moiety.

43. A process for preparing a coated optical fiber assembly comprising:
(1) applying to an optical fiber a coating formed from a reaction mixture comprising:
at least one base oligomer selected from at least one member of the group consisting of a urethane acrylate oligomer, a polyester acrylate and an acrylic acrylate, and
at least one radiation-curable diphenylmethane polyol oligomer, wherein each terminus of the polyol oligomer is capped by a reactive moiety capable of reacting with reactive termini of the base oligomer and other polyol oligomers; and
(2) radiation-curing said coating in situ.

44. The process of claim 43, wherein the reactive moiety is selected from the group consisting of acrylic, methacrylic, vinylic, allylic, styrenic, acrylamide, norbornenyl, acetylenic, epoxy, mercapto, amino, itanoic and crotonic moietie

44. The process of claim 43, wherein the base oligomer comprises a urethane acrylate oligomer and the reactive moiety is an acrylate moiety.
